(19) United States
(12) Patent Application Publication
(10) Pub. No.: US 2026/0302637 A1
(43) Pub. Date: Oct. 1, 2026

(54) MICROWAVE PATCH ANTENNA INCORPORATING ADJUSTABLE BESSEL RING REFLECTOR ELEMENT

(71) Applicant: AEROANTENNA TECHNOLOGY, INC., Chatsworth, CA (US)

(72) Inventors: Alex SISSOEV, Chatsworth, CA (US); Joseph KLEIN, Chatsworth, CA (US)

(21) Appl. No.: 19/090,566

(22) Filed: Mar. 26, 2025

(51) Int. Cl. H01Q 15/14; H01Q 9/04

(52) U.S. Cl. CPC H01Q 15/147; H01Q 9/0407

(57) ABSTRACT

A patch antenna may include a dielectric portion, a patch portion including conductive metal configured as an antenna element disposed on a face of the dielectric portion, and a reflector extending around lateral edges of the dielectric portion to influence a radiation pattern of the patch antenna based on an elevation of the reflector relative to an elevation of the patch portion and/or a diameter of the reflector.

### TECHNICAL FIELD

Example embodiments generally relate to the antenna subsystem interfaces and, more particularly, relate to antennas with custom radiation patterns.

### BACKGROUND

Microwave patch antennas offer a valuable tool in the design arsenal of antenna engineers. In this regard, patch antennas, which are often referred to alternatively as microstrip antennas, are typically initially formed as planar antenna elements that are integrated into a printed circuit board (PCB). The patch antennas therefore often have a low profile, making them advantageous for applications where space and/or weight is limited. Given these advantages, it may be appreciated that patch antennas are useful as aviation antennas, where a low profile reduces drag and a lighter weight is also desirable.

The patch antenna can, for example, be manufactured as a rectangular or circular shaped metallic “patch” that is mounted over a larger dielectric substrate that acts as a ground plane. In its simplest form, the patch antenna generally has little control over directivity of the antenna. However, there is often a desire for greater flexibility in relation to directivity of radiation patterns of aviation antennas.

Accordingly, it may be desirable to further improve this technology in order to reduce overall system weight, while providing greater adjustability of the radiation parameters of the patch antenna.

### BRIEF SUMMARY OF SOME EXAMPLES

In an example embodiment, a patch antenna may be provided. The patch antenna may include a dielectric portion, a patch portion including conductive metal configured as an antenna element disposed on a face of the dielectric portion, and a reflector extending around lateral edges of the dielectric portion to influence a radiation pattern of the patch antenna based on an elevation of the reflector relative to an elevation of the patch portion and/or a diameter of the reflector.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a patch antenna in accordance with an example embodiment;

FIG. 2 illustrates a top view of a patch antenna in accordance with an example embodiment;

FIG. 3 illustrates a side view of a patch antenna in accordance with an example embodiment;

FIG. 4 illustrates a plot of a radiation pattern of the patch antenna with a first selected diameter in accordance with an example embodiment;

FIG. 5 illustrates a plot of a radiation pattern of the patch antenna with a second selected diameter in accordance with an example embodiment; and

FIG. 6 illustrates block diagram of a patch antenna with adjustable diameter or elevation of a reflector in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

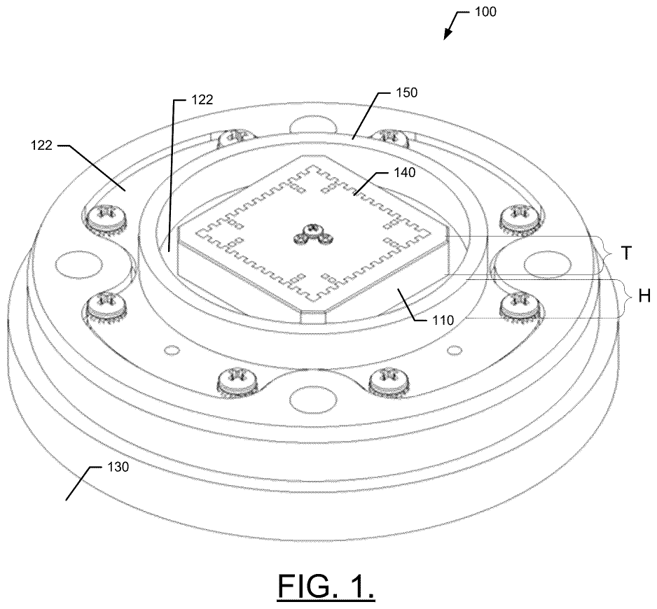

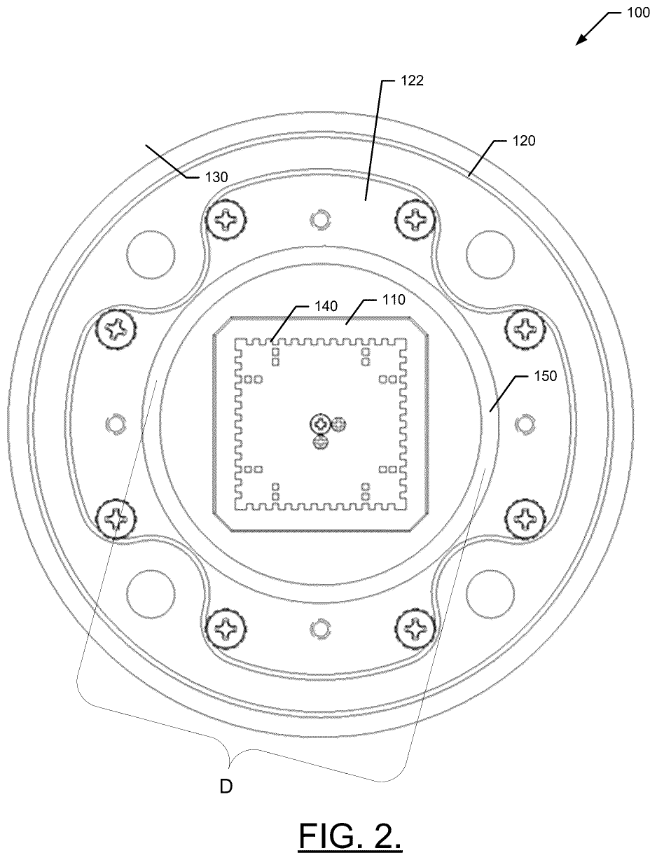

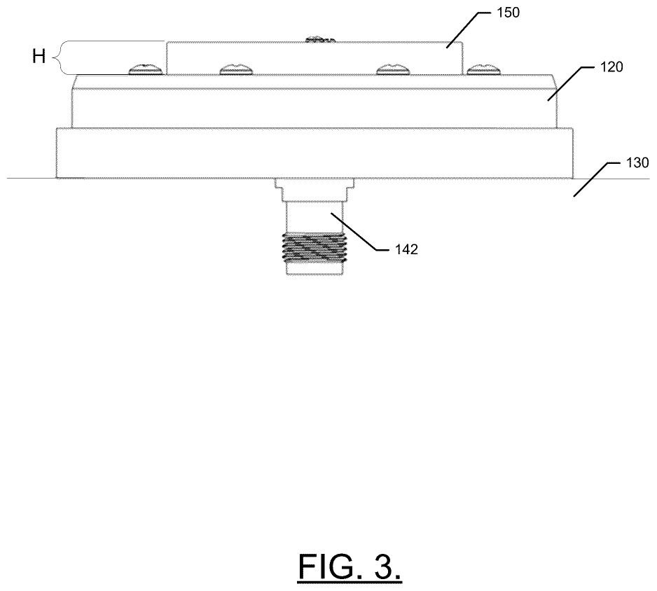

As discussed above, a patch antenna normally radiates with little directivity. Example embodiments aim to improve upon this weakness. FIG. 1 illustrates a perspective view of an example of a patch antenna 100 with improved directivity. FIG. 2 illustrates a top view of the patch antenna 100, and FIG. 3 illustrates a side view. Referring to FIGS. 1-3, the patch antenna 100 includes a dielectric portion 110 that acts as a ground plane. The dielectric portion 110 may be, for example, a ceramic base, often having a substantially rectangular prism shape (although other shapes including circular are possible). The dielectric portion 110 may be disposed at a mounting base 120, which may in turn be directly or indirectly operably coupled to a fuselage 130 of an aircraft (or another vehicle or component thereof). The mounting base 120 may have a mounting surface 122 that may extend parallel to a surface of the fuselage 130, and the dielectric portion 110 may in turn also be mounted in a plane that lies parallel to the surface of the fuselage 130 (e.g., on the mounting surface 122).

A conductively metallized patch portion 140 may be disposed on a face of the dielectric portion 110 that faces away from the fuselage 130. The patch portion 140 may extend in a plane that is substantially parallel to the mounting surface 122 of the mounting base 120, and also on an exposed face of the dielectric portion 110. Wires, cables, conductive runs, etc. (not shown) may be operably coupled to the patch portion 140 (e.g., inside the mounting base 120) to operably couple the patch portion 140 to radio equipment for either transmission or reception of radio frequency (RF) signals via the patch antenna 100 via a conduit 124. In an example embodiment, the patch antenna 100 may operate in the microwave spectrum (e.g., 300 MHz to 300 GHz).

To improve directivity of the patch antenna 100, example embodiments may further include a bessel ring reflector 150. The bessel ring reflector 150 may be formed from a conductive material (e.g., metal) that is formed to completely extend around external or lateral edges of the dielectric portion 110 and thereby provide directivity for the patch antenna 100. The bessel ring reflector 150 of an example embodiment may be annular in shape and may extend substantially perpendicularly away from the mounting surface 122.

In the depicted example of FIGS. 1-3, the dielectric portion 110 may have a thickness (T) that disposes the patch portion 140 a distance away from the mounting surface 122 that is equal to the thickness (T). Meanwhile, a height (H) of the bessel ring reflector 150 may be selected to have any desired amount of extension from the mounting surface 122 relative to the thickness (T). Thus, for example, if the height (H) is selected to be shorter than the thickness (T), the patch portion 140 may extend farther away from the mounting surface 122 than the bessel ring reflector 150. If instead the height (H) is selected to be longer than the thickness (T), the patch portion 140 may extend away from the mounting surface 122 less than the bessel ring reflector 150. However, if the height (H) is selected to be equal to the thickness (T), which is the case depicted in the example of FIGS. 1-3, the patch portion 140 and the bessel ring reflector 150 may be mounted flush with each other, and neither may extend farther away from the mounting surface 122 than the other.

In addition to the height (H), a diameter (D) of the bessel ring reflector 150 may be selected to alter the radiation pattern of the patch antenna 100. In the example shown, increasing the diameter (D) would increase a distance between the bessel ring reflector 150 and lateral edges of both the dielectric portion 110 and the patch portion 140. Thus, decreasing the diameter (D) would reduce the distance between the bessel ring reflector 150 and lateral edges of both the dielectric portion 110 and the patch portion 140.

Moreover, it should be appreciated that the bessel ring reflector 150 could take a different shape (e.g., rectangular or square) to match the shape of the lateral edges of the dielectric portion 110 if desired. Thus, the bessel ring reflector 150 need not necessarily be round. In such cases, it may be more appropriate to simply refer to a “reflector” than specifically the bessel ring reflector 150, which might be seen to unnecessarily imply some shape limitation.

The expression generally used for the radiation pattern of a circular aperture antenna in polar coordinates (assuming an idealized uniform aperture) can be written as:

$$E ( θ ) = {E}_{0} \cdot \vert \frac{2 {J}_{1} ( kD sin θ )}{kD sin θ} \vert$$

Where:
(E(θ)) is the electric field pattern as a function of angle (θ).
(E₀) is the maximum electric field strength.
(J₁) is the Bessel function of the first kind and first order:

$${J}_{1} ( ϕ ) = \frac{1}{π} {\int }_{0}^{π} cos ( ϕsin θ - θ ) , d θ$$

Where:

(k) is the wave number, given by

$$( k = \frac{2 π}{λ} ) ,$$

where (λ) is the wavelength of the signal.
(D) is the diameter of the circular aperture.
(θ) is the angle from the axis of the antenna.

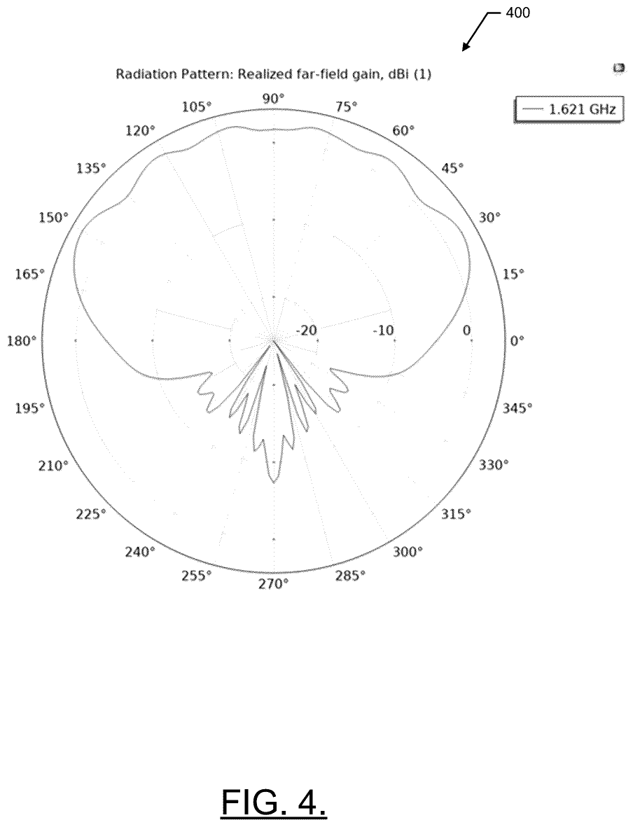

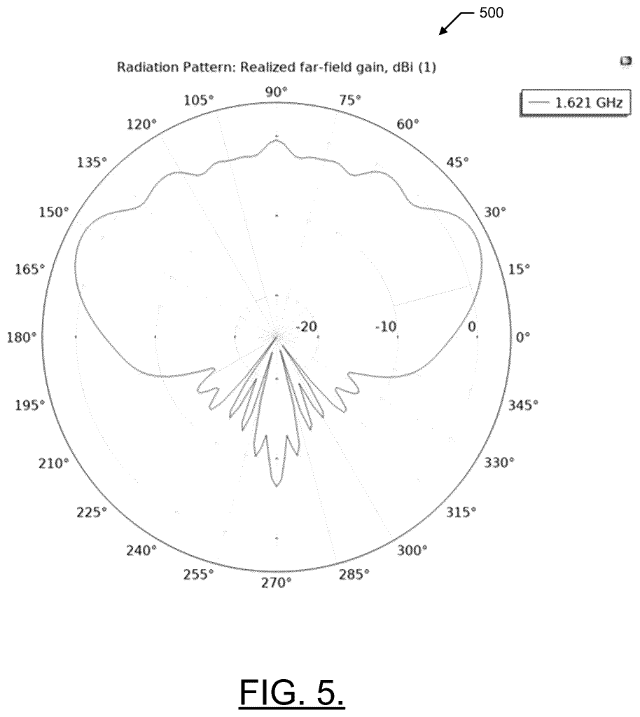

As can be appreciated from the equation above, radiation patterns can be adjusted by changing the diameter (D) of the aperture formed by the confines of the bessel ring reflector 150. In this regard, reducing the diameter (D) by just a few millimeters changes the elevation radiation pattern of a particular antenna to have more coverage at lower elevation angles. FIG. 4 illustrates a radiation pattern 400 for a realized far-field gain of in dBi associated with the patch antenna 100 of FIGS. 1-3 having a diameter (D) of 254 mm for a 1.621 GHz transmission. FIG. 5 shows a radiation pattern 500 for a realized far-field gain of in dBi associated with the patch antenna 100 of FIGS. 1-3 having a diameter (D) of 216 mm for a 1.621 GHz transmission.

Whereas one of skill in the art may simply make different models of antennas with corresponding different relationships between the height (H) of the bessel ring reflector 150 and the thickness (T) of the dielectric portion 110, or different models with corresponding different diameters (D) of the reflector (e.g., bessel ring reflector 150), some example embodiments may alternatively provide for variability of these parameters within a deployed antenna or via modification and adjustment of variable settings prior to deployment.

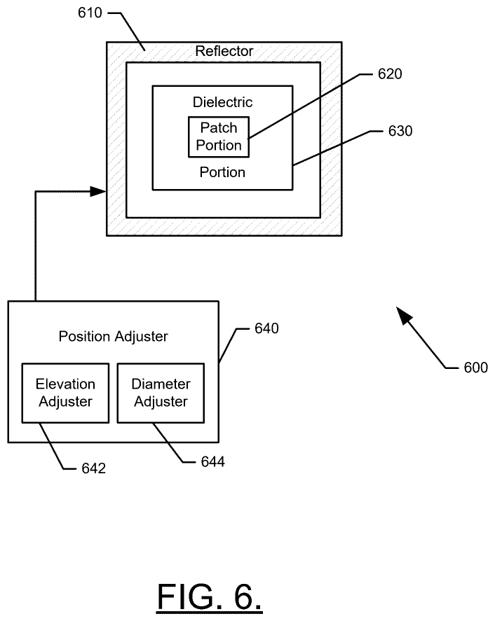

FIG. 6 illustrates an example embodiment of a patch antenna 600 with a variable position of a reflector 610 relative to a patch portion 620 and/or dielectric portion 630 of the patch antenna 600. In this regard, the variable position may be accomplished via a position adjuster 640, which is adjusted to change either or both of the elevation of the reflector 610 relative to the patch portion 620 and/or dielectric portion 630 and the diameter of the reflector 610. In particular, the position adjuster 640 may include an elevation adjuster 642 and/or a diameter adjuster 644 that perform these adjustments respectively. Although the adjusters can take many forms, in some cases, one or more threaded posts may extend from a mounting surface (e.g., similar to the mounting surface 122 of FIG. 1) and height adjustment may be accomplished by a nut assembly that carries the reflector 610 along the posts. Diameter adjustment may be accomplished via a threaded screw that engages portions of the reflector 610 that overlap each other to draw the overlapping portions tighter together (to reduce diameter), or extend the overlapping portions farther apart (to extend the diameter).

This methodology can be employed either to generate a radiation pattern that is not otherwise feasible with a conventional patch antenna, or to mitigate the effects of the antenna's surroundings (ground planes, positioning, etc.). Adjusting height and diameter may allow for precise control to tailor the device to specific application needs, influencing radiation patterns in order to enhance antenna performance to achieve optimal signal propagation and reception. Example embodiments may be particularly beneficial in scenarios where traditional patch antennas fall short, enabling the generation of complex, customized radiation patterns that meet unique requirements. Additionally, this approach provides a practical solution to counteract environmental interferences, such as the presence of ground planes or suboptimal positioning, which can otherwise degrade antenna performance. The adaptability of the reflector dimensions contributes significantly to the versatility and efficiency of the antenna system, making it a valuable tool in advanced communication technologies.

Thus, an example embodiment may provide a patch antenna that may include a dielectric portion, a patch portion including conductive metal configured as an antenna element disposed on a face of the dielectric portion, and a reflector extending around lateral edges of the dielectric portion to influence a radiation pattern of the patch antenna based on an elevation of the reflector relative to an elevation of the patch portion and/or a diameter of the reflector.

The patch antenna described above (and an antenna subsystem comprising the same) may include additional features, modifications, augmentations and/or the like to achieve further objectives or enhance operation of the system. The additional features, modifications, augmentations and/or the like may be added in any combination with each other. For example, the diameter and/or elevation of the reflector may be adjustable. In this regard, for example, the patch antenna may further include a diameter adjuster operably coupled to the reflector to change the diameter of the reflector and/or an elevation adjuster operably coupled to the reflector to change the elevation of the reflector. In an example embodiment, the reflector may be annular shaped to form a bessel ring reflector. In some cases, the elevation of the patch portion may be selected such that the patch portion is flush with a highest elevation of the reflector. Alternatively, the elevation of the patch portion may be selected such that the patch portion is at a lower elevation than a highest elevation of the reflector, or the elevation of the patch portion may be selected such that the patch portion is at a higher elevation than a highest elevation of the reflector. In an example embodiment, the patch portion and the reflector may each have a square or rectangular shape. In some cases, the patch portion may have a square or rectangular shape and the reflector has a circular shape. In an example embodiment the patch antenna may operate at microwave frequencies. In some cases, the patch antenna may be disposed at a fuselage of an aircraft.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A patch antenna comprising:
a dielectric portion;
a patch portion comprising conductive metal configured as an antenna element disposed on a face of the dielectric portion; and
a reflector extending around lateral edges of the dielectric portion to influence a radiation pattern of the patch antenna based on an elevation of the reflector relative to an elevation of the patch portion and/or a diameter of the reflector.

2. The patch antenna of claim 1, wherein the diameter of the reflector is adjustable.

3. The patch antenna of claim 2, further comprising a diameter adjuster operably coupled to the reflector to change the diameter of the reflector.

4. The patch antenna of claim 1, wherein the elevation of the reflector is adjustable.

5. The patch antenna of claim 4, further comprising an elevation adjuster operably coupled to the reflector to change the elevation of the reflector.

6. The patch antenna of claim 1, wherein both the diameter of the reflector and the elevation of the reflector are adjustable, and
wherein the patch antenna further comprises a diameter adjuster operably coupled to the reflector to change the diameter of the reflector and an elevation adjuster to change the elevation of the reflector.

7. The patch antenna of claim 1, wherein the reflector is annular shaped to form a bessel ring reflector.

8. The patch antenna of claim 1, wherein the elevation of the patch portion is selected such that the patch portion is flush with a highest elevation of the reflector.

9. The patch antenna of claim 1, wherein the elevation of the patch portion is selected such that the patch portion is at a lower elevation than a highest elevation of the reflector.

10. The patch antenna of claim 1, wherein the elevation of the patch portion is selected such that the patch portion is at a higher elevation than a highest elevation of the reflector.

11. The patch antenna of claim 1, wherein the patch portion and the reflector each have a square or rectangular shape.

12. The patch antenna of claim 1, wherein the patch portion has a square or rectangular shape and the reflector has a circular shape.

13. The patch antenna of claim 1, wherein the patch antenna operates at microwave frequencies.

14. The patch antenna of claim 1, wherein the patch antenna is disposed at a fuselage of an aircraft.
